(19) United States
(12) Patent Application Publication
(10) Pub. No.: US 2002/0093901 A1
(43) Pub. Date: Jul. 18, 2002

(54) First-side dual-layer optical data storage disk and method of manufacturing the same

(76) Inventors: David H. Davies, Boulder, CO (US); David Blankenbeckler, Longmont, CO (US); Michael Braitberg, Boulder, CO (US)

Correspondence Address: David E. Steuber, SKJERVEN MORRILL MacPHERSON LLP, 25 Metro Drive, Suite 700, San Jose, CA, 95110-1349, US

(21) Appl. No.: 09/764,042

(22) Filed: Jan. 16, 2001

(51) Int. Cl. G11B 7/00

(52) U.S. Cl. 369/109.01

(57) ABSTRACT

An optical data storage disk includes a central substrate and on each side of the substrate a pair of metal/alloy recording layers separated by a transparent layer, preferably made of a photopolymer resin. Thus the disk includes a total of four recording layers. The disk is a “first-side” disk, in the sense that the laser beam used to read and write data enters the disk from the same side as the layer to be read or written, i.e., the laser beam does not pass through the central substrate. The disk is manufactured by a process that includes coating the inner metal/alloy layers with the photopolymer resin in liquid form, embossing the data for the outer metal layers on the photopolymer resin coatings with a transparent stamper, and then curing the photopolymer resin by directing UV radiation through the transparent stamper.

### FIELD OF THE INVENTION

This invention relates to optical data storage disks and, in particular, to an optical data storage disk wherein the data-carrying layers are read from or written to by a laser beam that originates from the side of the disk on which the data-carrying layers are located.

### BACKGROUND OF THE INVENTION

Optical data storage disks typically contain a data-carrying layer which is made of a metal or metal alloy. The data can be recorded in several different ways. For example, each data track can contain a series of pits or bumps that are read by the reflected laser beam. The data layer can be an alloy that is generally in an amorphous state, and the data bits may consist of crystalline areas that have a higher reflectivity than the amorphous material and therefore can be read by the laser beam. One such material is a SbInSn alloy described in U.S. Pat. No. 4,960,680, issued Oct. 2, 1990, and assigned to Eastman Kodak Company. In magneto-optical disks the polarity of the laser beam is altered by the bits recorded in the data layer.

In most optical disks, and this includes the well-known CD and DVD disks, the metal/alloy layer is formed on a clear plastic substrate and is read by directing the laser beam through the substrate. Thus the data layer is located on the opposite or “second” side of the disk from the laser.

There is a never-ending quest to increase the data capacity of optical disks. For example, the standard CD disk can hold 650 megabytes in a single metal layer, and a single layer of a DVD disk can hold 4.7 gigabytes. One way of essentially doubling the capacity of a disk is to provide a second data layer to be read by the laser. An advantage of this technique is that, assuming the data is recorded in the same manner on both of the layers, such a disk can be read by the same disk drive that normally reads the single layer with a few minor adjustments (primarily a system to permit the disk drive determine which layer is being read). Importantly, for example, the same 658 μm wavelength red laser can be used.

FIG. 1 shows a cross-sectional view of a second-side dual-layer disk 10, an example of which is the DVD-9 disk. Disk 10 is a laminate containing polycarbonate substrates 11 and 19, on which the data (pits) are embossed in a normal manner. Substrates 11 and 19 are typically about 600 μm thick. Metal/alloy layers 12 and 14 are coated on the data surfaces of substrates 11 and 19, again in the conventional manner, and a polymer resin layer 13, typically about 50 μm thick, is interposed between the metal/alloy layers 12 and 14. As indicated, the data is read by shining a laser through substrate 11 to read metal/alloy layer 12 and through substrate 11 and layer 13 to read metal/alloy layer 14. Disk 10 is manufactured by essentially making two disks and laminating them together with the polymer resin layer 13. Layer 13 can be spun onto one of the disks, the other disk can be applied to the exposed surface of the layer 13, and layer 13 can be cured with UV light.

FIG. 2 shows a cross-sectional view of a proposed DVD-18 disk, which is a double version of the disk 10 shown in FIG. 1. Disk 20 contains two halves 26A and 26B. Disk half 26A contains a polycarbonate substrate 21A, a metal/alloy layer 22A, a polymer resin layer 23A, a metal/alloy layer 24A and a polycarbonate substrate 25A. Disk half 26B contains identical layers. Each of disk halves 26A and 26B is manufactured separately and then the halves are bonded together at the interface between polycarbonate substrates 25A and 25B. Each of disk halves 26A and 26B is similar to disk 10, except that substrates 25A and 25B are only about 100 μm thick.

The manufacture of disks 10 and 20 is a cumbersome and expensive process. Disk 10 requires two molding steps, and disk 20 requires four molding steps. This is a significant problem inasmuch as molding capacity is at a premium. Another problem is that the laser beam must traverse a 600 μm polycarbonate substrate to read from or write to one of the data layers and a 600 μm polycarbonate substrate and a 50 μm polymer resin layer to read from or write to the other data layer. This creates problems of aberration and wave front distortion, which make it difficult to maintain image quality. Moreover, these problems become more severe as the wavelength of the laser beam decreases. Since future generations of optical disks will likely be designed for shorter wavelength lasers which allow higher recording densities (e.g., a 400 nm blue laser), the structures shown in FIGS. 1 and 2 do not offer much promise.

What is needed is a dual-layer optical data storage disk that is relatively easy to manufacture, in particular minimizing the number of molding steps; that avoids the image quality problems described above; and that is more useful at wavelengths shorter than 650 nm.

### SUMMARY OF THE INVENTION

These objectives are achieved in a first-side optical data storage disk in accordance with this invention. The disk includes a circular substrate having first and second principal surfaces; a first metal/alloy layer overlying the first principal surface of the substrate; a first transparent layer overlying the first metal/alloy layer; and a second metal/alloy layer overlying the first transparent layer. Each of the metal/alloy layers is adapted to be read by a laser beam that does not pass through said substrate. In this way, the data storage capacity of the disk can be essentially doubled without the problems that occur when the laser beam must traverse a relatively thick substrate. Advantageously, the disk has an identically structured opposite side and can be fabricated using a single dual-side injection-molded substrate.

The first transparent layer can be a curable material, for example, a photopolymer resin.

The invention also includes reading the first-side optical data storage disk by directing a laser beam such that the laser beam is partially reflected from and partially transmitted through the second metal/alloy layer, detecting a first portion of the laser beam that is reflected from the first metal/alloy layer and detecting a second portion of the laser beam that is reflected from the second metal alloy layer.

The first-side optical data storage disk of this invention can be fabricated by an inventive process. The process includes depositing the first metal/alloy layer over the first principal surface of the substrate; depositing a layer of a curable liquid over the first metal/alloy layer; embossing a data pattern on the layer of curable liquid; curing and solidifying the layer of curable liquid; and depositing the second metal/alloy layer over the solidified layer of curable liquid.

According to another aspect, the invention includes a method of detecting which of the metal/alloy layers is being read by reading a data pattern written on one of the layers, by detecting the reflectivity of one of said metal/alloy layers, or by detecting the characteristics of a focus response curve.

A number of advantages are realized by using the principles of this invention:

A dual-layer double-sided optical data storage disk is manufactured using a single injection-molded substrate. Alternative processes require two separate molding operations and two individual plastic substrates, which must be laminated together in a complex and exacting process.

A problem inherent in dual layer structures is that the laser beam must traverse at least one layer of transparent plastic. This causes optical distortion and wave front aberration and creates a limit to performance and density. In prior art structures, the laser beam must traverse both the relatively thick substrate and a second layer separating the dual recording layers. In a disk according to this invention, the laser beam need only traverse the relatively thin layer that separates the recording layers. Since the effects of distortion and aberration are generally additive with thickness, the utility of dual layers in traditional “second-side” disks is limited.

A two-sided disk according to this invention can be manufactured in a continuous process wherein both sides of the disk are processed simultaneously.

The use of a dual-layer disk essentially doubles the recording capacity of the disk without affecting the compatibility of the disk with existing optical heads. This is not the case, for example, with other options such as increasing the recording density by using a laser beam having a shorter wavelength. On the other hand, the absence of a thick substrate avoids the problems of aberration and wave front distortion, and this makes embodiments of this invention particularly useful in conjunction with laser beams having wavelengths in the range of 350 to 450 nm, in particular a blue laser with a wavelength of approximately 400 nm.

### BRIEF DESCRIPTION OF THE DRAWINGS

The invention will be best understood by reference to the following description and drawings. In the drawings, like elements are given the same reference numerals. The drawings are not to scale.

FIG. 1 is a cross-sectional view of a conventional optical data storage disk having two recording layers.

FIG. 2 is a cross-sectional view of a conventional optical data storage disk having four recording layers.

FIG. 3 is a cross-sectional view of an optical data storage disk of this invention having four metal/alloy layers.

FIG. 4 is a detailed view of one of the metal/alloy layers and a protective coating.

FIGS. 5A-5G illustrate the steps of a process of fabricating the disk shown in FIG. 3.

FIGS. 6A and 6B show a technique for applying the layer of photopolymer resin.

FIGS. 6C-6E show a technique for embossing the data pattern in the layer of photopolymer resin using a transparent stamper.

FIG. 7 is a conceptual view of a line for performing the process described in FIGS. 5A-5G.

FIGS. 8A-8F illustrate the steps of a process of fabricating the transparent stamper.

FIG. 9A is a graph of the error signal generated by the focus servo system; and FIG. 9B is a graph of the sum signal generated by the focus servo system.

FIG. 10 is a graph showing the reflectivity of an InSbSn alloy layer as a function of the thickness of the layer.

### DESCRIPTION OF THE INVENTION

As used herein, the following terms have the meanings set forth below:

“Metal/alloy” means any metal or metal alloy or compound used in an optical (including phase-change, passive reflective, and magneto-optical) data storage disk to replicate or record data. For example, if the data is recorded as a series of pits or bumps, the metal/layer could be aluminum or an alloy of aluminum such as Al, 2% Si. Metal/alloy also includes materials such as the SbInSn alloy described in U.S. Pat. No. 4,960,680 which change from an amorphous state to a crystalline state when exposed to radiation of sufficient intensity. Other examples of phase change materials are the class of materials called chalcogenides (alloys of germanium, antimony, and tellurium and the like) several of which are taught in U.S. Pat. Nos. 4,719,594 and 5,789,055 and at pages 65-80 of the proceedings of the 2000 Optical Data Storage (ODS) Conference (IEEE catalog #OTH8491, Library of Congress #99-68427). Examples of magneto-optical recording layers are alloys of terbium, gadolinium, iron and cobalt, as taught for example at pages 83-95 of the 2000 ODS Conference, supra, and in The Physical Principles Of Magneto-Optical Recording, by Masud Mansuripur, section 1.8, pages 45 et seq., 1998 ed., Cambridge Press (ISBN 0 521 634 18 0). A “metal/alloy” layer can be used to serve as: (i) a simple read reflector for the reading of pre-embossed information and also to provide a tracking and focusing surface (e.g., aluminum); (ii) a write-once material that can be written once and not rewritten, while being reflective enough to provide the read function described above (e.g., InSnSb); and (iii) a rewriteable material that can be written to and then rewritten, while being reflective enough to provide the read function described above (examples are the chalcogenides (phase change rewriteable) and the rare earth transition metals (magneto-optical rewriteable)).

“Over”, “overlying”, “under” and “underlying” refer to a relationship between two elements (e.g., layers or surfaces) in which one element is located above or below the second element but may be separated from the second layer by one or more intervening materials. Thus the two elements involved may be, but are not necessarily, in contact with each other. Moreover, these terms are not restricted to any particular spatial orientation, in particular the orientation of the elements as shown in the drawings. For example, if the structure shown in a drawing is inverted, an element depicted in the drawing as “overlying” would actually be “underlying”.

An optical data storage disk 30 according to the invention is shown in cross-section in FIG. 3. Disk 30 is a laminate which includes a central polycarbonate substrate 34 which is overlain by a first metal/alloy layer 35. Overlying metal alloy/layer 35 is a first transparent layer 36, and overlying layer 36 is a second metal/alloy layer 37. Underlying substrate 34 in succession are a third metal alloy/layer 33, a second transparent layer 32, and overlying layer 36, and a fourth metal/alloy layer 31. Transparent layers 33 and 36 are formed of a photopolymer resin, i.e., a polymer resin that is initially a liquid but that cures to a solid form when exposed to radiation (e.g., ultraviolet (UV) light). In place of a photopolymer resin, other kinds of curable materials such as heat-curable polymers could be used, e.g., a two-part epoxy polymer (catalyzed, for example, by peroxides). The shrinkage of the polymer upon heat-curing should preferably be less than approximately 15-20%.

Although the well known plastic material “polycarbonate” has been used to illustrate the substrate 34 ( for example the grade of polycarbonate called Lexan OQ™, available from GE Plastics ), it can be readily appreciated that other “engineering grade” injection moldable plastics could be used for the substrate. An alternate material, for example, is Noryl™ plastic, also available from GE Plastics. More discussion of this subject is provided in application Ser. No. 09/652,975, filed Aug. 24, 2000, which is incorporated herein by reference in its entirety. A distinguishing advantage of this invention is that the substrate need not be substantially transparent to the laser radiation and need not have low birefringence.

In one embodiment, disk 30 is 32 mm in diameter and has a track pitch of approximately 0.74 μm and a minimum feature size of about 435 nm. Substrate 34 can be in the range of 200 to 1000 μm thick and is typically about 500 μm thick, and transparent layers 32 and 36 could be about 50 μm thick. Metal/alloy layers 31, 33, 35 and 37 could be about 80 nm thick. Using the advantages of this invention, such a disk has a recording capacity of approximately 1 gigabyte.

Disk 30 is a first-side disk, meaning that the laser beam used to read metal/alloy layers 35 and 37, represented by “laser 1” and “laser 2” in FIG. 3, does not pass through substrate 34. Similarly, metal/alloy layers 31 and 33 are read by a laser beam (not shown) directed at disk 30 from below.

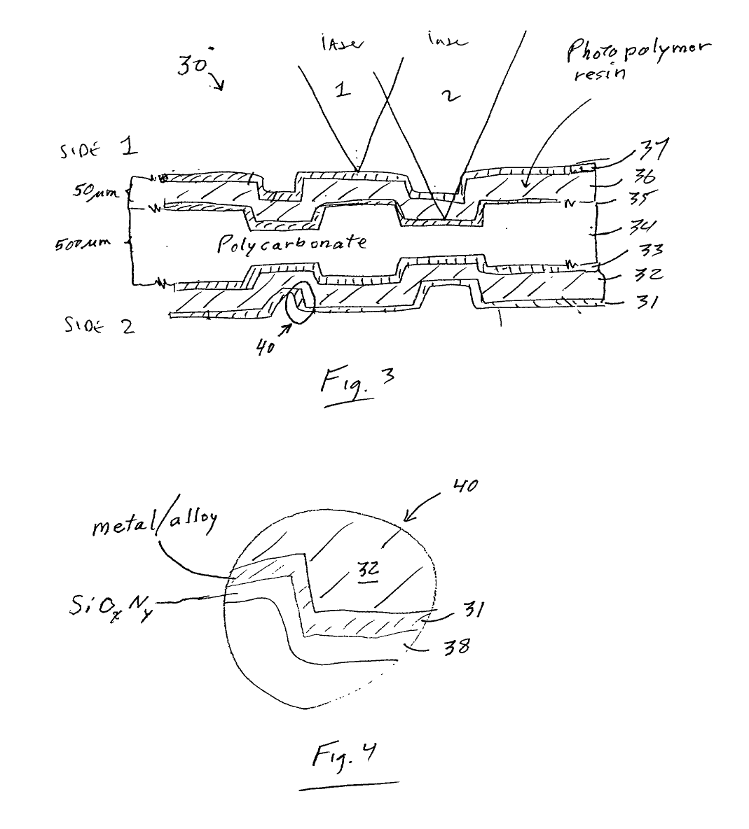

Not shown in FIG. 3 but shown in the detail 40 of FIG. 4, metal/alloy layer 31 is covered by a protective coating 38 which in this embodiment is formed of silicon oxynitride (SiOₓN_{y}). Coating 38, which could also be made of some other inorganic dielectric such as silicon dioxide (SiO₂), protects metal/alloy layer 31 and also optically couples metal/alloy layer 31 to the surrounding environment (air). There would typically be a similar coating (not shown) on metal/alloy layer 37. In some embodiments, there could be similar dielectric coatings on metal/alloy layers 33 and 35, but this may not be necessary inasmuch as metal/alloy layers 33 and 35 are not exposed to air and may not require optical coupling. Protective coating 38 could be about 80 nm thick.

Polycarbonate substrate 34 is preferably fabricated in a single molding step, using the process described in the above-referenced application Ser. No. 09/652,975. The molding process forms data patterns, represented by the pits in FIG. 3, or, if either of metal/alloy layers 33 or 35 is to be writeable, features such as grooves or lands that would be used by the tracking mechanism during writing. Both sides of substrate 34 are preferably molded simultaneously, thereby avoiding the need for multiple sequential molding processes.

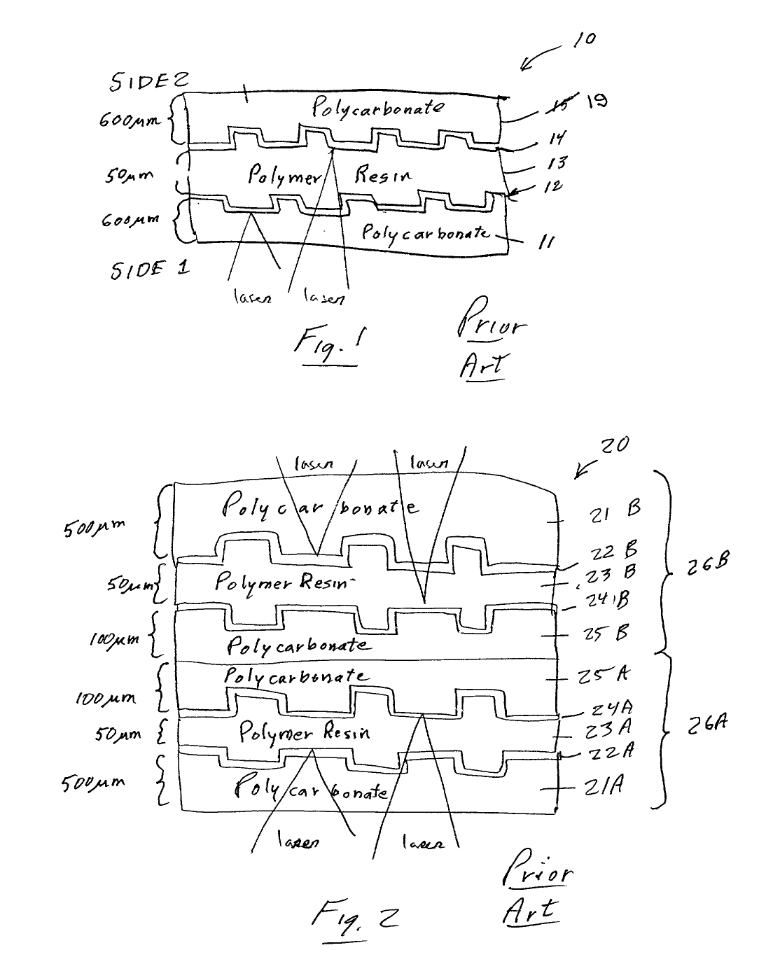

While disk 30 has four metal/alloy recording layers, the total thickness of disk 30 is only about 600 μm. This thickness is achieved largely by limiting the thickness of the transparent layers 32 and 36 to about 50 μm, and it could not easily be achieved if disk 30 were formed by laminating several substrates together, as described above in connection with FIGS. 1 and 2. A substrate 50 μm thick, for example, would not be easy to work with inasmuch as it would have no physical rigidity or stiffness. Instead, in the process described further below, layers 32 and 36 are deposited onto substrate 34 in viscous liquid form, the data patterns which support metal/alloy layers 31 and 37 are impressed into the viscous, partially-cured liquid, and the liquid is further cured to solidify the data patterns.

The thickness of transparent layers 32 and 36 was chosen to be approximately 50 μm because 50 μm is sufficiently large that the focus scheme of a disk drive could normally discriminate between the light reflected from, for example, metal/alloy layers 35 and 37. Conversely, if transparent layer 36 were too thin (e.g., <15 μm), the light reflected from both of the metal/alloy layers 35 and 37 would be almost “in focus”, and the drive's reading system would have difficulty determining which layer is being read. Note that the thickness 50 μm is not an absolute limit; in some embodiments, transparent layers 32 and 36 might be 40 μm thick, for example. In all cases, however, the transparent layers are preferably thick enough (>15 μm) to avoid the reading problem described above. On the other hand, if the thickness of the transparent layers exceeds approximately 200 μm, then the advantage of minimizing optical aberration may be lost.

There are several techniques for detecting which metal/alloy layer is being read. First, a code identifying which metal/alloy is being read could be included in the data that is premastered in each metal/alloy layer, e.g., along with the sector address. Second, the reflectivity of the metal/alloy layers will typically be different, and therefore the drive could determine which layer is being read by detecting the intensity of the reflected light, which would be an indication of the reflectivity of the metal/alloy layer. Third, each metal/alloy layer has a characteristic focus response curve which represents the size of the “spot” formed on the layer as the focus of the laser beam changes. The beam is in focus when the spot is at a minimum size, and the spot gets larger as the focal point moves in either direction above or below the layer. The shape of these response curves, generally an “S”, varies depending on the distance between the layer and the lens. A focus response curve is normally generated as the focussing system “locks on to” a particular layer, and thus this curve can be used to determine which layer is being locked onto.

The method of locating the surface of the metal/alloy layers uses the focus servo of the disk drive and can be understood by reference to FIGS. 9A and 9B. FIG. 9A is a graph of the error signal generated by the focus servo system; and FIG. 9B is a graph of the sum signal generated by the focus servo system. First, the servo system moves the focusing lens far away from the surface of the disk. The servo system then slowly brings the lens closer to the disk while the digital signal processing (DSP) system samples the normalized focus error signal and the sum signal as shown in FIGS. 9A and 9B. If it is desired to focus on the outer metal/alloy layer (31, 37), then the DSP system closes the loop (focus loop) after identifying the first sum signal peak (FIG. 9B) and the first focus error signal zero (FIG. 9A). If it is desired to focus on the inner metal/alloy layer (33, 35), the DSP system ignores the first sum signal and first focus error signal and identifies the second the second sum signal (FIG. 9B) and the second focus error signal zero (FIG. 9A) and closes the loop. If it is desired to identify which surface is locked then the lens is initially moved to the position distant from the disk and then the above process is repeated. The first surface identified is the surface closest to the lens of the optical head.

As an adjunct to the above techniques, another alternative is to use reflectivity or focus response, as described above, to detect which layer is being read and then write a layer identification code onto each of the metal/alloy layers, i.e., a layer identification code is predefined so as to enable the drive to determine which layer is being read. This could be done when the disk is first written after receipt by the user.

Regardless of which technique is used, if the drive determines that it is reading the wrong layer, e.g., the data intended to be read is on layer 35 whereas the drive is actually reading layer 37, the focal point is shifted by the distance between the layers and the drive locks on to the other layer.

From FIG. 3 it is evident that metal/alloy layers 31 and 37 must transmit a portion of the incident light if metal/alloy layers 33 and 35 are to be read from or written to. If layers 33 and 35 are writeable, layers 31 and 37 should be from 25% to 50% transmissive at the laser wavelength being used. If, on the other hand, layers 33 and 35 are read-only layers (i.e., reflective only), layers 31 and 37 can be as low as 10% transmissive. To ensure that proper tracking and focusing can be achieved, all of the metal/alloy layers should be at least 15% reflective. In addition, the inner layers 33 and 35 should be less than 5% transmissive to avoid problems with the laser beam passing through substrate 34 and reflecting from the metal/alloy layers on the other side of the substrate. These optical properties are controlled by controlling the thickness of metal/alloy layers. For example, FIG. 10 is a graph showing the reflectivity of an InSbSn alloy layer (both amorphous and crystalline states) as a function of the thickness of the layer, at a wavelength of 650 nm.

One attractive possibility is to make the inner metal/alloy layers 33 and 35 read-only (reflective) layers while the outer metal/alloy layers 31 and 37 are at least partially writeable. This yields a disk with some writeable area without the need to provide sufficient laser power to write data to the inner layers 33 and 35.

Application Ser. No. 09/393,150, filed Sep. 10, 1999, describes a system of digital rights management in which a Content Key™ code is contained in a writeable area of the disk. The Content Key™ code essentially unlocks specified portions in the prerecorded area of the disk and allows them to be read by the user. For example, a disk might contain ten musical selections of which only five are accessible to the user. The user may obtain access to additional selections by purchasing a code which provides access to those selections. The dual-layer disk of this invention is particularly suitable for this type of digital rights management because a portion of only one of the metal/alloy layers on each side of the disk (preferably an outer layer) needs to contain a writeable portion; the other layer can be a read-only layer. The Content Key™ code in the writeable layer can be used to control access to data premastered on the read-only layer or a premastered area of the writeable layer. The control is exercised through readable coded data that informs the system which disk sectors are allowed to be accessed.

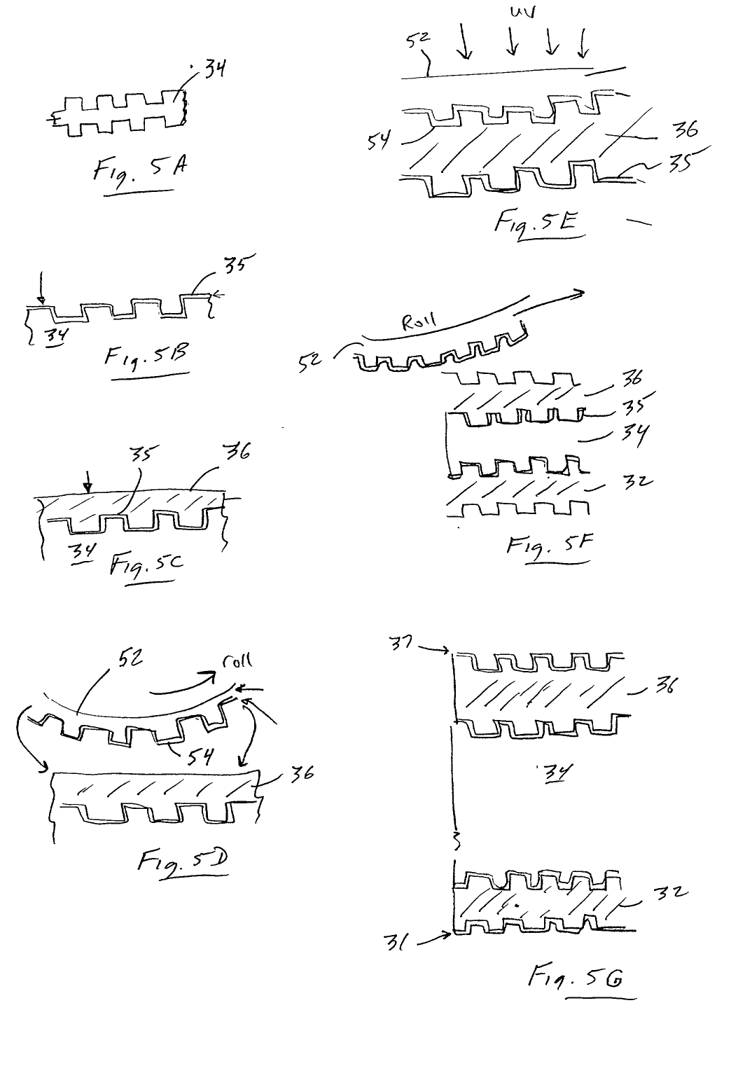

FIGS. 5A-5G illustrate the steps of a process for fabricating disk 30 shown in FIG. 3. FIG. 7 is a conceptual view of a line for carrying out the process of FIGS. 5A-5H.

The process starts with a substrate 34, shown in FIG. 5A, made of polycarbonate or a similar material, which is molded using the process described in application Ser. No. 09/652,975 with premastered data (or tracking features) on both sides. Next, as shown in FIG. 5B, metal/alloy layer 35 is deposited on the top surface of substrate 34. This is typically done by physical vapor deposition (evaporation) or by sputtering. Metal/alloy layer 35 can be formed either of a reflective metal such as aluminum or a writeable alloy such as SbInSn. If layer 35 is aluminum it might be 50 nm thick; if layer 35 is SbInSn it might be 80 nm thick. Optionally, a 100 nm-thick SiOₓN_{y} protective coating (not shown) can be formed over metal/alloy layer 35.

Note that metal/alloy layer 33 (not shown) is formed simultaneously on the opposite surface of substrate 34. While FIGS. 5B-5D show only one side of disk 30, it will be understood that an identical process is preferably performed on the other side of the disk. To do this, the substrates may, for example, be placed in annular trays which support the edges of the substrates but leave both the upper and lower principal surfaces largely exposed.

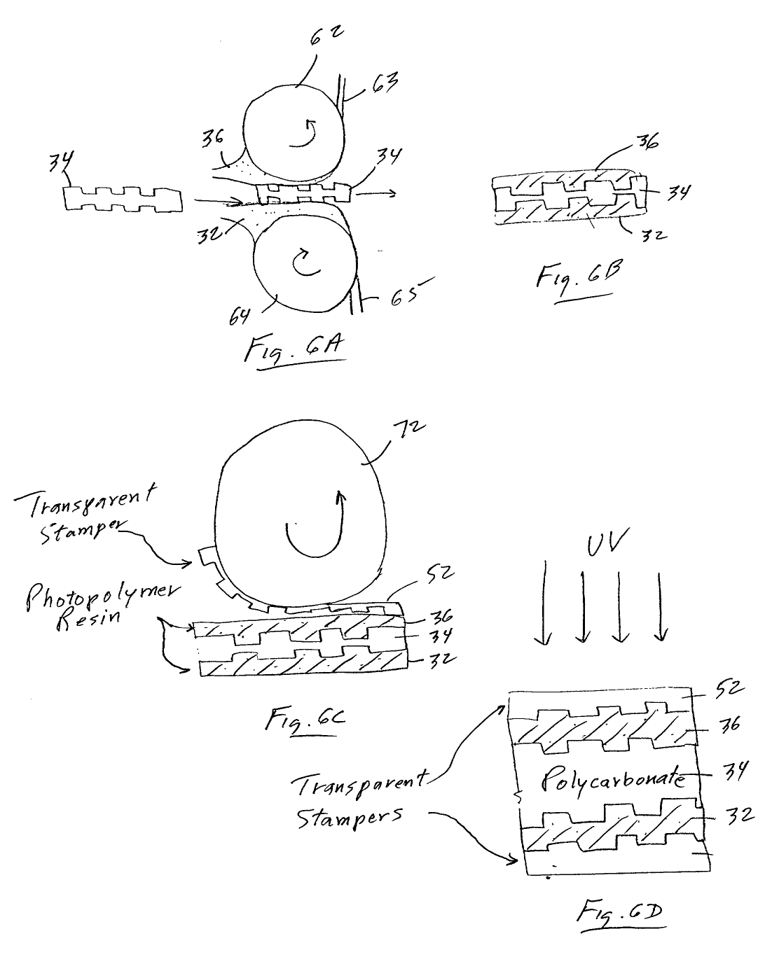

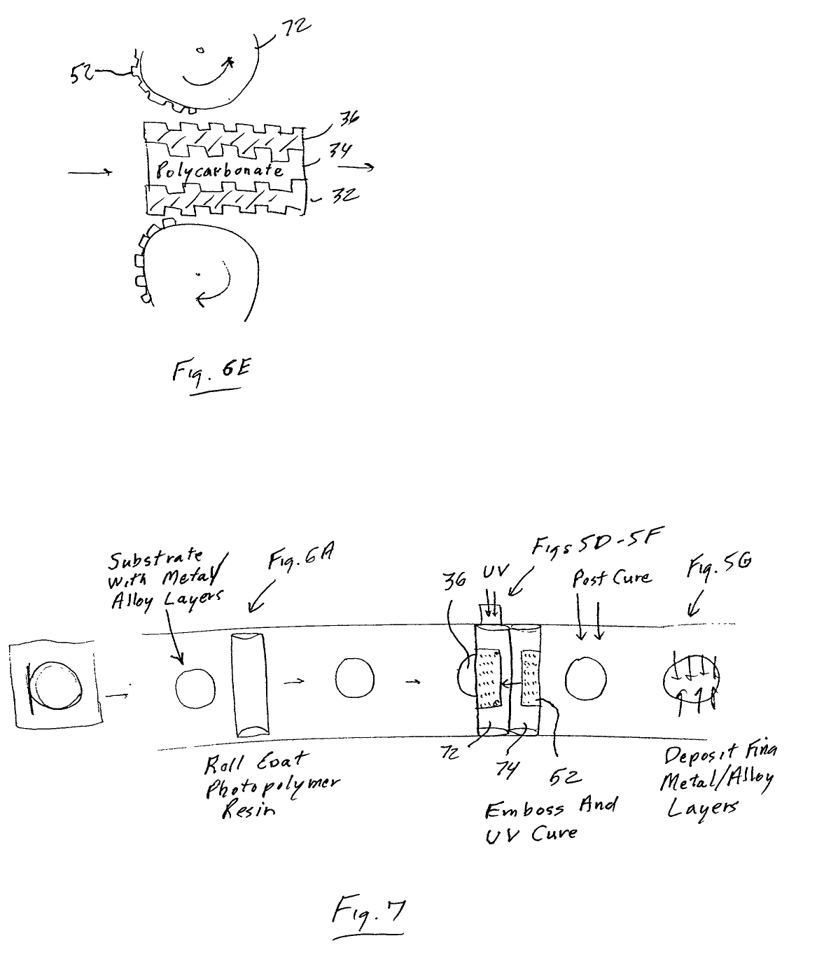

As shown in FIG. 5C, transparent layer 36 of a viscous photopolymer resin is applied over metal/alloy layer 35. As described above, photopolymer resins are viscous liquids at room temperature. When exposed to UV or some other radiation, photopolymer resins can transition to a state of partial cure, and upon further exposure they can be further cured or hardened into a solid. As shown in FIG. 5C, layer 36 is still in a viscous liquid state. Layer 36 can be applied to substrate 34 by several processes, including spin-coating, spraying, rolling and slot die coating. FIG. 6A illustrates a way of rolling layers 32 and 36 onto substrate 34 using a pair of rollers 62 and 64. A pair of “doctor blades” 63 and 65 control the amount of liquid photopolymer resin that is applied to substrate 34, and doctor blades 63, 65 along with the speed of the rollers 62, 64 and the temperature and viscosity of the resin can be adjusted to provide a very consistent thickness of layers 32 and 36. The techniques of roller-coating are well known in the art and therefore are not discussed in detail here. Once layers 32, 36 have been applied to substrate 34, they can be allowed stand for a short period to level off, as shown in FIG. 6B.

Methods of applying such viscous coatings and having them flow into a smooth surface are well known in practice. Control over such parameters as rheology, surface tension, rate of evaporation, and rate of application, and the use of surface treatments to allow displacement of the surface air have been the subject of much study. The simultaneous coating of both sides of a moving web is also a proven technology. Methods of applying such coatings include the application of forward roll, reverse roll, slot die coating, slide coating, etc. For a general discussion see, for example, “Take a closer look at coating problems” by L. E. Scriven and W. J. Suszynski, in the September 1990 edition of Chemical Engineering Progress”, pages 24-29, and the references cited therein.

Returning to FIGS. 5D and 5E, a transparent stamper 52 is now brought against the photopolymer resin in layer 32 to emboss a data pattern into layer 32. Transparent stamper 52, which is described further below, contains a release coating 54 consisting of a material such as gold which will prevent transparent stamper 52 from adhering to layer 32. Transparent stamper 52 is preferably attached to a belt which encircles several rollers. For example, FIG. 7 shows transparent stamper 52 running over rollers 72, 74.

As shown in FIG. 5E, as transparent stamper 52 is forced against the liquid photopolymer resin in layer 36, a UV beam is directed through transparent stamper and into layer 36. This cures the photopolymer resin, causing it to harden. The release coating 54 then allows transparent stamper 52 and layer 36 to separate, whereas layer 36 remains attached to metal/alloy layer 35, as shown in FIG. 5F. FIGS. 6C and 6D are additional conceptual views of the operation of the transparent stamper 52 and the application of UV radiation to cure the photopolymer resin.

Several mechanisms are known to induce photo-polymerization in a material. The most generally used involves the use of chemical free radical agents that are generated from UV-induced photolysis. These radical agents can include such species as peroxides. The radicals induce chemical cross-linking between the existing polymer chains, or in prepolymers or pure monomer liquids, and hence create a “mat” of high molecular weight polymers which is often a dense and solidified material. The advantage of such a process is that it occurs without significant change in physical density, and hence there is minimal shrinkage in the material. Also, by avoiding the use of thermal effects the damaging impact of thermal expansion and contraction is minimized. It also an advantage that the chemical material systems used avoid the use of solvents and other volatile materials, as these materials can cause further shrinkage when they evaporate.

Although the process depends upon the photo cure process, it also advantageous to provide some embossing pressure at step shown in FIG. 5E, typically a pressure of about 10-100 kg/cm² can be applied. It is also advantageous to ensure that the material being imprinted with the data pattern is several degrees above the point where the maximum loss modulus resides so that it is readily deformed.

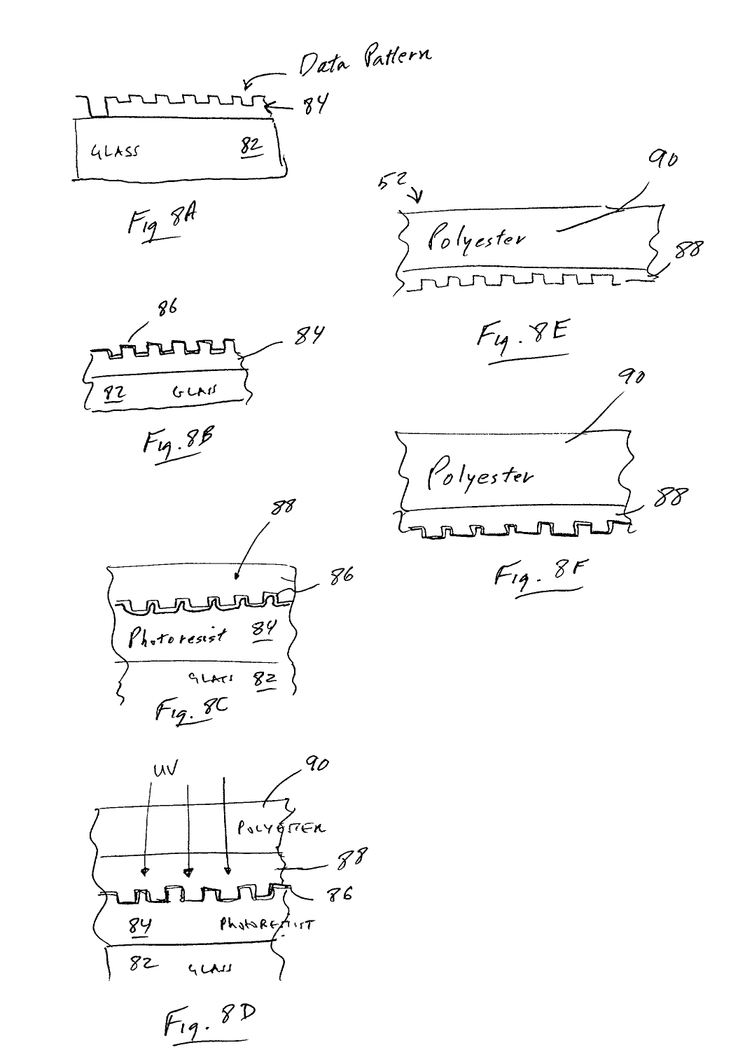

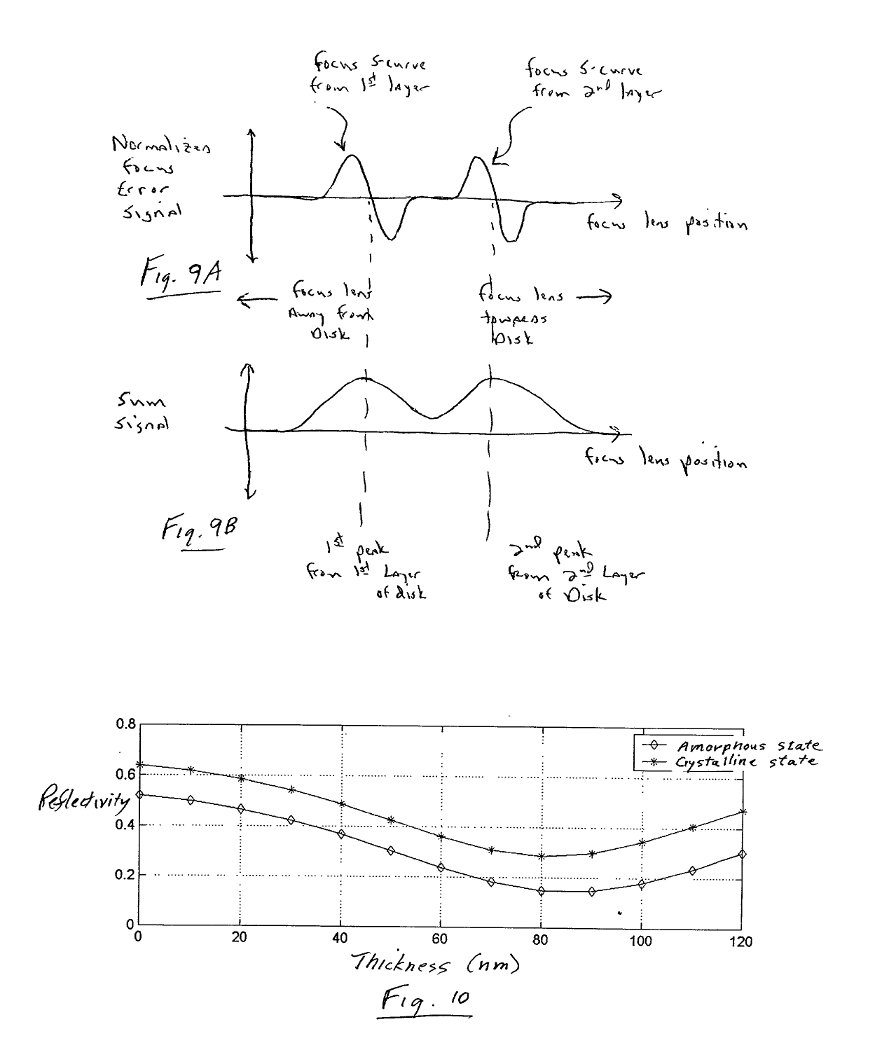

The specific photopolymer materials used for both the process to make the transparent stamper (as shown in FIG. 8 ) and also to make the replicated surface (as shown in FIGS. 5 and 6) are known to technologists in the field. For example, photopolymers that can be used include thermoplastic epoxy polymers that include glycidyl functionality. These polymers can be initiated by the halogen salts of the diazonium family, typically 2-3% by weight. The compositions can also include copolymers containing the epoxide functional group, typically 30% by weight. Also, U.S. Pat. Nos. 4,374,077, 4,363,844, and 4,519,065 contain detailed descriptions of usable photopolymers.

After the photopolymer resin has been cured, disk 30 proceeds to further processing stations where metal/alloy layers 37 and 31 are applied, preferably by sputtering or evaporation, and where protective coatings are deposited over the metal/alloy layers. The resulting disk 30 is shown in FIG. 5G.

FIGS. 8A-8F illustrate the steps of a process of forming transparent stamper 52. The process begins with the manufacture of a master disk in the normal matter. A smoothly polished piece of glass 82 (e.g., 1/2 inch thick) is coated with a photoresist layer 84, typically about 100 nm thick. Photoresist layer 84 is cured, and a data pattern is defined on photoresist layer 84 with a laser beam. As shown in FIG. 8A, photoresist layer 84 is then developed, revealing the data pattern as a series of pits or bumps along a spiral or circular track. As shown in FIG. 8B, a release layer 86 is deposited on the surface of photoresist layer 84 by sputtering or evaporation. For example, release layer 86 could be a layer of gold 40 nm thick.

As shown in FIG. 8C, a layer 88 of a liquid photopolymer resin is then deposited to a thickness of, for example, 50 μm. This can be done, for example, by roller-coating, slot die coating spinning or spraying. Next, as shown in FIG. 8D, a thin sheet 90 of transparent polyester, typically 1-2 mils thick, is laminated to layer 88, and layer 88 is cured with UV light, causing layer 88 to bond to polyester sheet 90.

The laminate of layer 88 and polyester sheet 90 is then pealed from photoresist layer 84, producing the structure shown in FIG. 8E. This produces the transparent stamper 52. As shown in FIG. 8F, the data surface of transparent stamper 52 is then coated with release layer 54 by sputtering or evaporation. Release layer 54 can be gold at a thickness of 40 nm. The stamper should be substantially transparent to the UV radiation used to cure the photopolymer resin 32, 36, as shown in FIGS. 6C and 6D.

The foregoing description is intended to be illustrative and not limiting. Many alternative embodiments in accordance with the broad principles of this invention will be apparent to persons of skill in the art. For example, some embodiments according to this invention may include three or more recording layers on one side of the substrate.

We claim:

1. A first-side optical data storage disk comprising:
a circular substrate having first and second principal surfaces;
a first metal/alloy layer overlying said first principal surface of said substrate;
a first transparent layer overlying said first metal/alloy layer; and
a second metal/alloy layer overlying said first transparent layer, wherein each of said metal/alloy layers is adapted to be read by a laser beam that does not pass through said substrate.

2. The first-side optical data storage disk of claim 1 wherein said first principal surface of said substrate comprises premastered data which includes a series of pits and/or bumps, said first metal/alloy layer conforming to the shape of said pits and/or bumps.

3. The first-side optical data storage disk of claim 2 wherein the transmissivity of said second metal/alloy layer at the wavelength of said laser beam is greater than 10%.

4. The first-side optical data storage disk of claim 2 wherein said first metal/alloy layer contains a writeable area.

5. The first-side optical data storage disk of claim 1 wherein said first metal/alloy layer contains a writeable area.

6. The first-side optical data storage disk of claim 5 wherein the transmissivity of said second metal/alloy layer at the wavelength of said laser beam is in the range of 25% to 50%.

7. The first-side optical data storage disk of claim 5 wherein said second metal/alloy layer contains a writeable area.

8. The first-side optical data storage disk of claim 1 wherein said second metal/alloy layer comprises premastered data which includes a series of pits and/or bumps.

9. The first-side optical data storage disk of claim 1 wherein said second metal/alloy layer contains a writeable area.

10. The first-side optical data storage disk of claim 1 wherein said first metal/alloy layer comprises aluminum.

11. The first-side optical data storage disk of claim 10 wherein said second metal/alloy layer comprises SbInSn.

12. The first-side optical data storage disk of claim 1 comprising:
a third metal/alloy layer underlying said second principal surface of said substrate;
a second transparent layer uderlying said third metal/alloy layer; and
a fourth metal/ally layer underlying said second transparent layer.

13. The first-side optical data storage disk of claim 12 wherein said second principal surface of said substrate comprises premastered data which includes a series of pits and/or bumps in said substrate, said third metal/alloy layer conforming to the shape of said pits and/or bumps.

14. The first-side optical data storage disk of claim 13 wherein said third metal/alloy layer contains a writeable area.

15. The first-side optical data storage disk of claim 12 wherein said second metal/alloy layer comprises premastered data which includes a series of pits and/or bumps.

16. The first-side optical data storage disk of claim 15 wherein said second metal/alloy layer contains a writeable area.

17. The first-side optical data storage disk of claim 13 wherein said second metal/alloy layer contains a writeable area.

18. The first-side optical data storage disk of claim 1 wherein said substrate comprises polycarbonate.

19. The first-side optical data storage disk of claim 1 wherein said first transparent layer comprises a photopolymer resin.

20. The first-side optical data storage disk of claim 1 wherein said first transparent layer comprises a curable polymer.

21. The first-side optical data storage disk of claim 1 wherein said first transparent layer comprises a UV curable material.

22. The first-side optical data storage disk of claim 1 wherein said substrate has a thickness in the range of 200 to 1000 μm.

23. The first-side optical data storage disk of claim 22 wherein said substrate has a thickness of approximately 500 μm.

24. The first-side optical data storage disk of claim 1 wherein said first transparent layer has a thickness in the range of 15 to 200 μm.

25. The first-side optical data storage disk of claim 24 wherein said first transparent layer has a thickness of approximately 50 μm.

26. The first-side optical data storage disk of claim 1 comprising a protective coating between said first metal/alloy layer and said first transparent layer.

27. The first-side optical data storage disk of claim 1 comprising a protective coating overlying said second metal/alloy layer.

28. The first-side optical data storage disk of claim 27 comprising a second protective coating underlying said fourth metal/ally layer.

29. The first-side optical data storage disk of claim 28 wherein said protective coating is exposed to the atmosphere.

30. The first-side optical data storage disk of claim 1 wherein the reflectivity of said first and second metal/alloy layers at the wavelength of said laser beam is at least 15%.

31. The first-side optical data storage disk of claim 1 wherein said disk is less than 50 mm in diameter.

32. The first-side optical data storage disk of claim 31 wherein said disk is at or below 32 mm in diameter.

33. The first-side optical data storage disk of claim 1 wherein said first metal/alloy layer is a read-only layer and said second metal/alloy layer comprises a writeable area, said writeable area comprising a code which permits access to a portion of data recorded on the first metal/alloy layer.

34. The first-side optical data storage disk of claim 33 wherein said coded permits access to a portion of data recorded on the second metal/alloy layer.

35. A method of reading data from the first-side optical data storage disk of claim 1 comprising:
directing a laser beam such that the laser beam is partially reflected from and partially transmitted through the second metal/alloy layer:
detecting a first portion of the laser bean that is reflected from the first metal/alloy layer; and
detecting a second portion of the laser beam that is reflected from the second metal alloy layer.

36. The method of claim 35 wherein the laser beam has a wavelength in the range of 350 to 450 nm.

37. The method of claim 36 wherein the laser beam has a wavelength of approximately 400 nm.

38. The method of claim 35 wherein the laser beam has a wavelength of approximately 650 nm.

39. A method of reading data from and/or writing data to the first-side optical data storage disk of claim 1 comprising:
using a laser beam to read data from and/or write data to said first metal/alloy layer; and
using a laser beam to read data from and/or write data to said second metal/alloy layer
wherein said laser beam does not pass through said substrate.

40. The method of claim 39 comprising detecting which of said metal/alloy layers is being read.

41. The method of claim 40 wherein detecting which of said metal/alloy layers is being read comprises reading a data pattern written on one of said layers, said data pattern indicating the layer on which said data pattern is written.

42. The method of claim 41 wherein said data pattern is premastered.

43. The method of claim 41 wherein said data pattern was written on said layer using a laser beam.

44. The method of claim 40 wherein detecting which of said metal/alloy layers is being read comprises detecting the reflectivity of one of said metal/alloy layers.

45. The method of claim 40 wherein detecting which of said metal/alloy layers is being read comprises detecting a feature of a focus servo response curve.

46. The method of claim 39 wherein the laser beam has a wavelength in the range of 350 to 450 nm.

47. The method of claim 46 wherein the laser beam has a wavelength of approximately 400 nm.

48. The method of claim 39 wherein the laser beam has a wavelength of approximately 650 nm.

49. A method of manufacturing a first-side dual-layer optical data storage disk comprising:
providing a substrate having data premastered on at least a first principal surface of said substrate;
depositing a first metal/alloy layer over said first principal surface;
depositing a layer of a curable liquid over said first metal/alloy layer;
embossing a data pattern on said layer of curable liquid;
curing and solidifying said layer of curable liquid; and
depositing a second metal/alloy layer over said solidified layer of curable liquid.

50. The method of claim 49 wherein embossing a data pattern on said curable liquid comprises applying a transparent stamper to said liquid and directing UV light onto said liquid.

51. The method of claim 50 wherein directing UV light onto said liquid comprises directing UV light through said transparent stamper.

52. The method of claim 49 wherein depositing a second metal/alloy layer comprises sputtering.

53. The method of claim 49 wherein depositing a second metal/alloy layer comprises evaporation.

54. The method of claim 49 wherein data is premastered on a second principal surface of said substrate, said method comprising:
depositing a third metal/alloy layer under said second principal surface;
depositing a second layer of a curable liquid under said first metal/alloy layer;
embossing a data pattern on said second layer of curable liquid;
curing solidifying said second layer of curable liquid; and
depositing a fourth metal/alloy layer under said layer of curable liquid.

55. The method of claim 49 wherein the laser beam has a wavelength in the range of 350 to 450 nm.

56. The method of claim 55 wherein the laser beam has a wavelength of approximately 400 nm.

57. The method of claim 49 wherein the laser beam has a wavelength of approximately 650 nm.
